(19) United States
(12) Patent Application Publication
(10) Pub. No.: US 2021/0273281 A1
(43) Pub. Date: Sep. 2, 2021

(54) CYLINDRICAL BATTERY AND BATTERY MODULE

(71) Applicant: SANYO Electric Co., Ltd., Osaka-shi, Osaka (JP)

(72) Inventor: Yuji Yamagami, Osaka (JP)

(73) Assignee: SANYO Electric Co., Ltd., Daito-shi, Osaka (JP)

(21) Appl. No.: 17/259,715

(22) PCT Filed: Jun. 21, 2019
(86) PCT No.: PCT/JP2019/024669

§ 371 Date: Jan. 12, 2021

(30) Foreign Application Priority Data
Jul. 17, 2018 (JP) 2018-134109

(51) Int. Cl. H01M 50/107; H01M 50/147; H01M 50/30; H01M 50/183

(52) U.S. Cl. CPC H01M 50/107; H01M 50/183; H01M 50/30; H01M 50/147

(57) ABSTRACT

A cylindrical battery (10) according to an exemplary embodiment includes a cylindrical battery case (15) including a bottomed cylindrical exterior casing (16) and a sealing unit (17) fitted to close an opening of the exterior casing (16). A bottom portion (16b) of the exterior casing (16) is provided with an exhaust valve (28), and the sealing unit (17) is provided with an exhaust valve (24). An outer peripheral surface of the battery case (15) has a higher emissivity in a first region extending from the axial center of the battery case (15) to the same side as the bottom portion (16b) than in a second region located on the same side as the sealing unit (17).

### TECHNICAL FIELD

The present disclosure relates to a cylindrical battery and a battery module using the batteries.

### BACKGROUND ART

In recent years, battery modules including a plurality of cylindrical batteries have been used in automotive batteries or the like. The safety of individual batteries, and also the safety of the module itself are extremely important. In general, at least either of a bottom portion of an exterior casing, or a sealing unit of a cylindrical battery is provided with an exhaust valve for discharging a gas generated inside the battery in the event that the internal pressure of the battery rises due to abnormal heat generation or the like. For example, Patent Literature 1 discloses a cylindrical battery in which a bottom portion of an exterior casing is annularly reduced in thickness to define an exhaust valve, the area percentage of the exhaust valve being not less than 10% of the area of the bottom portion.

### CITATION LIST

### Patent Literature

PTL 1: WO 2014/045569

### SUMMARY OF INVENTION

### Technical Problem

In the event that a gas is not smoothly discharged through an exhaust valve, a so-called lateral burst may occur in which a sidewall portion of an exterior casing is broken open. If, for example, a lateral burst of an exterior casing occurs in a battery module, the heat of the high-temperature gas is propagated to nearby batteries and the like. Thus, it is an important challenge to protect exterior casings from a lateral burst.

### Solution to Problem

A cylindrical battery according to an aspect of embodiments is a cylindrical battery that includes a cylindrical battery case including a bottomed cylindrical exterior casing and a sealing unit fitted to close an opening of the exterior casing, wherein a bottom portion of the exterior casing, or the sealing unit is provided with an exhaust valve, and an outer peripheral surface of the battery case has a higher emissivity in a first region extending from the axial center of the battery case to the same side as the exhaust valve than in a second region located on a side opposite to the exhaust valve.

A cylindrical battery according to another aspect of embodiments is a cylindrical battery that includes a cylindrical battery case including a bottomed cylindrical exterior casing and a sealing unit fitted to close an opening of the exterior casing, wherein a bottom portion of the exterior casing, and the sealing unit are each provided with an exhaust valve, and an outer peripheral surface of the battery case has a higher emissivity in a first region extending from the axial center of the battery case to the same side as the bottom portion than in a second region located on the same side as the sealing unit.

A battery module according to another aspect of embodiments is a battery module that includes a plurality of the cylindrical batteries described above, wherein the cylindrical batteries are arranged on the same plane while the axial directions of the respective battery cases are parallel to one another.

### Advantageous Effects of Invention

In the event that the battery internal pressure rises due to abnormality and reaches a predetermined value, the cylindrical batteries according to the present disclosure allow the gas generated inside the battery to be smoothly discharged through the exhaust valve, and thus can sufficiently suppress the occurrence of a lateral burst in the exterior casing. Further, the battery module constructed with the cylindrical batteries of the present disclosure can achieve enhanced safety of the module.

### BRIEF DESCRIPTION OF DRAWINGS

FIG. 1 is a sectional view of a nonaqueous electrolyte secondary battery according to an exemplary embodiment.

FIG. 2 is a front view of a nonaqueous electrolyte secondary battery according to an exemplary embodiment.

FIG. 3 is a front view of a nonaqueous electrolyte secondary battery according to another exemplary embodiment.

### DESCRIPTION OF EMBODIMENTS

As described hereinabove, it is an important challenge to protect an exterior casing from a lateral burst which leads to thermal propagation to nearby batteries and the like. The present inventor carried out extensive studies directed to solving this problem, and have found that a gas can be smoothly discharged through an exhaust valve by configuring a cylindrical battery so that a vicinity of the exhaust valve will be preferentially heated when the cylindrical battery is subjected to a hot environment. In the cylindrical batteries according to the present disclosure, the first region on the outer peripheral surface of the battery case is designed to have a higher emissivity than the second region so that a vicinity of the exhaust valve will be preferentially heated.

The battery module using the cylindrical batteries with the above configuration is sufficiently prevented from a lateral burst of the exterior casing even if the internal pressure of the cylindrical battery is increased. Thus, thermal propagation between the batteries mediated by high-temperature gas is suppressed.

Hereinbelow, embodiments of the cylindrical batteries according to the present disclosure will be described in detail with reference to the drawings. The cylindrical batteries of the present disclosure may be primary batteries or secondary batteries. Further, the batteries may be batteries using an aqueous electrolyte, or may be batteries using a nonaqueous electrolyte. In the following, a cylindrical battery 10 that is a nonaqueous electrolyte secondary battery (a lithium ion battery) using a nonaqueous electrolyte will be described as an exemplary embodiment. However, the cylindrical batteries of the present disclosure are not limited thereto.

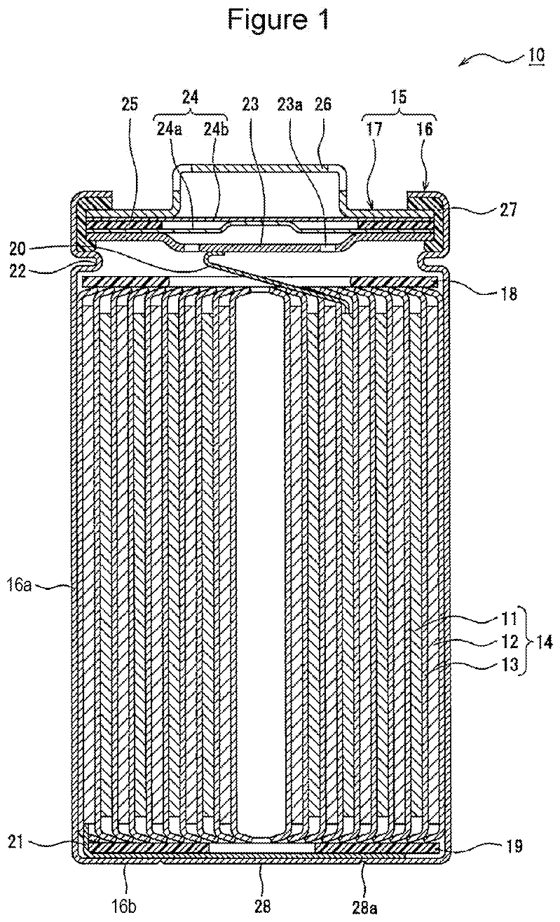

FIG. 1 is a sectional view of the cylindrical battery 10. As illustrated in FIG. 1, the cylindrical battery 10 includes a wound electrode assembly 14, a nonaqueous electrolyte (not shown), and a cylindrical battery case 15 in which the electrode assembly 14 and the nonaqueous electrolyte are accommodated. The electrode assembly 14 has a wound structure in which a positive electrode 11 and a negative electrode 12 are wound via a separator 13. The battery case 15 is composed of a bottomed cylindrical exterior casing 16, and a sealing unit 17 which closes the opening of the exterior casing 16. Further, the cylindrical battery 10 includes a resin gasket 27 disposed between the exterior casing 16 and the sealing unit 17.

The nonaqueous electrolyte includes a nonaqueous solvent and an electrolyte salt dissolved in the nonaqueous solvent. Examples of the nonaqueous solvents which may be used include esters, ethers, nitriles, amides, and mixtures of two or more kinds of these solvents. The nonaqueous solvent may include a halogenated solvent resulting from the substitution of the above solvent with a halogen atom such as fluorine in place of at least part of hydrogen. The nonaqueous electrolyte is not limited to a liquid electrolyte, and may be a solid electrolyte such as a gel polymer. For example, a lithium salt such as LiPF₆ is used as the electrolyte salt.

The electrode assembly 14 is composed of a long positive electrode 11, a long negative electrode 12, two long sheets of separators 13, a positive electrode lead 20 attached to the positive electrode 11, and a negative electrode lead 21 attached to the negative electrode 12. To prevent the precipitation of lithium, the negative electrode 12 is one size larger than the positive electrode 11. Specifically, the negative electrode 12 is formed larger than the positive electrode 11 in the longer direction and the width direction (the shorter direction). The two sheets of separators 13 are one size larger than at least the positive electrode 11, and are arranged, for example, so as to interpose the positive electrode 11 therebetween.

The positive electrode 11 includes a positive electrode current collector and positive electrode mixture layers disposed on both sides of the current collector. The positive electrode current collector may be, for example, a foil of a metal that is stable at the potentials of the positive electrode 11, such as aluminum or an aluminum alloy, or a film having such a metal as a skin layer. The positive electrode mixture layers include a positive electrode active material, a conductive agent and a binder. For example, the positive electrode 11 may be fabricated by applying a positive electrode mixture slurry including components such as a positive electrode active material, a conductive agent and a binder onto a positive electrode current collector, drying the wet films, and pressing the coatings to form positive electrode mixture layers on both sides of the current collector.

The positive electrode active material is principally composed of a lithium metal composite oxide. Examples of the metal elements which may be contained in the lithium metal composite oxides include Ni, Co, Mn, Al, B, Mg, Ti, V, Cr, Fe, Cu, Zn, Ga, Sr, Zr, Nb, In, Sn, Ta and W. A preferred example of the lithium metal composite oxides is composite oxide containing at least one of Ni, Co, Mn and Al.

Examples of the conductive agents which may be used in the positive electrode mixture layers include carbon materials such as carbon black, acetylene black, Ketjen black and graphite. Examples of the binders which may be used in the positive electrode mixture layers include fluororesins such as polytetrafluoroethylene (PTFE) and polyvinylidene fluoride (PVdF), polyacrylonitriles (PAN), polyimides, acrylic resins and polyolefins. These resins may be used in combination with, for example, cellulose derivatives such as carboxymethylcellulose (CMC) and salts thereof, and polyethylene oxide (PEO).

The negative electrode 12 includes a negative electrode current collector and negative electrode mixture layers disposed on both sides of the current collector. The negative electrode current collector may be, for example, a foil of a metal that is stable at the potentials of the negative electrode 12, such as copper or a copper alloy, or a film having such a metal as a skin layer. The negative electrode mixture layers include a negative electrode active material and a binder. For example, the negative electrode 12 may be fabricated by applying a negative electrode mixture slurry including components such as a negative electrode active material and a binder onto a negative electrode current collector, drying the wet films, and pressing the coatings to form negative electrode mixture layers on both sides of the current collector.

The negative electrode active material is generally a carbon material capable of reversibly storing and releasing lithium ions. Preferred carbon materials are graphites including natural graphites such as scaly graphite, massive graphite and earthy graphite, and artificial graphites such as massive artificial graphite and graphitized mesophase carbon microbeads. The negative electrode mixture layers may include a Si-containing compound as a negative electrode active material. Further, for example, a metal other than Si that is alloyabie with lithium, an alloy containing such a metal, or a compound containing such a metal may be used as a negative electrode active material.

Examples of the binders which may be used in the negative electrode mixture layers include fluororesins, PAN, poiyimide resins, acrylic resins and polyolefin resins, similarly to the case of the positive electrode 11. Styrene-butadiene rubber (SBR) or a modified product thereof may be preferably used. The negative electrode mixture layers may include, for example, CMC or a salt thereof, polyacrylic acid (PAA) or a salt thereof, or polyvinyl alcohol, in addition to, for example, SBR or the like.

The separator 13 is a porous sheet having ion permeability and insulating properties. Specific examples of the porous sheets include microporous thin films, woven fabrics and nonwoven fabrics. Some preferred materials for the separators 13 are olefin resins such as polyethylene and polypropylene, and celluloses. The separator 13 may have a monolayer structure or a multilayer structure. A heat resistant layer or the like may be disposed on the surface of the separator 13.

Insulating plates 18, 19 are disposed on and under the electrode assembly 14, respectively. In the example illustrated in FIG. 1, the positive electrode lead 20 attached to the positive electrode 11 extends toward the sealing unit 17 through a through-hole in the insulating plate IS, and the negative electrode lead 21 attached to the negative electrode 12 extends along the outside of the insulating plate 19 to a bottom portion 16b of the exterior casing 16. The positive electrode lead 20 is connected by welding or the like to the lower side of a bottom plate 23 of the sealing unit 17. Thus, a cap 26 that is a top plate of the sealing unit 17 and is electrically connected to the bottom plate 23 serves as a positive electrode terminal. The negative electrode lead 21 is connected by welding or the like to the inner side of the bottom portion 16b of the exterior casing 16, thus allowing the exterior casing 16 to serve as a negative electrode terminal.

The exterior casing 16 is a bottomed cylindrical metal container having a substantially cylindrical sidewall portion 16a and a bottom portion 16b that is circular in-bottom view. The exterior casing 16 is generally composed of a metal principally including iron or aluminum. The exterior casing 16 has a grooved portion 22 which is formed by, for example, pressing the sidewall portion 16a from the outside and which supports the sealing unit 17. The grooved portion 22 is preferably an annular portion which extends along the circumference of the exterior casing 16, and supports the sealing unit 17 on the upper side thereof. Further, an upper end portion of the exterior casing 16 is inwardly crimped to fix a peripheral edge portion of the sealing unit 17. A gasket 27 is disposed between the exterior casing 16 and the sealing unit 17 to seal the inner space of the battery case 15.

The bottom portion 16b of the exterior casing 16 is provided with an exhaust valve 23 that opens when the internal pressure of the battery reaches a predetermined value. Further, in the cylindrical battery 10, an exhaust valve 24 is also disposed in the sealing unit 17. That is, the cylindrical battery 10 has gas discharging mechanisms at both ends in the axial direction of the battery case 15. For example, an annular groove 28a is disposed in the bottom portion 16b, and the portion enclosed by the groove 23a serves as an exhaust valve 28 that opens when the internal pressure reaches a predetermined pressure. The groove 28a is a channel marked on the outer side of the bottom portion 16b. The groove 28a reduces the thickness of the bottom portion 16b compared to other portions and thus this thin portion will break preferentially in the event of an increase in internal pressure.

For example, the groove 28a has a perfectly circular shape in bottom view and is formed concentrically with the outer peripheral edge of the bottom portion 16b. The shape of the groove 23a in bottom view is not particularly limited and may be, for example, a perfectly circular shape, a semicircular shape, a polygonal shape, etc. A perfectly circular shape is preferable from points of view such as durability during normal use and the operability of the exhaust valve upon increase in internal pressure.

The sealing unit 17 has a structure in which a bottom plate 23, a lower valve 24a, an insulating member 25, an upper valve 24b and a cap 26 are stacked in this order from the electrode assembly 14 side. The lower valve 24a and the upper valve 24b constitute the exhaust valve 24. Each of the members constituting the sealing unit 17 has, for example, a disk shape or a ring shape, and the members except the insulating member 25 are electrically connected to one another. The bottom plate 23 has at least one through-hole 23a. The lower valve 24a and the upper valve 24b are connected to each other in the respective central portions, and the insulating member 25 is interposed between peripheral portions of the valves.

The cylindrical battery 10 is designed so that the exhaust valve 24 of the sealing unit 17 will be operated at a lower pressure than the exhaust valve 23 of the bottom portion 16b. Further, the cylindrical battery 10 is designed so that a larger amount of gas will be discharged through the exhaust valve 23 on the bottom portion 16b side than through the exhaust valve 24 on the sealing unit 17 side. For example, the openable area of the exhaust valve 28 is larger than the open area of the through-hole 23a formed in the bottom plate 23 of the sealing unit 17. Because the exhaust valve 28 of the bottom portion 16b is directly exposed to the outside of the battery, the gas can be discharged efficiently and the gas discharge route passing the exhaust valve 28 is unlikely to be blocked. The openable area of the exhaust valve 28 is not particularly limited but is preferably 10% to 70%, and more preferably 15% to 50% of the total area of the bottom portion 16b. The thin portion of the exhaust valve 28 (the portion defined by the groove 28a) is smaller in thickness than, for example, a thin portion of the exhaust valve 24 and is easily broken upon increase in internal pressure.

In the event that the internal pressure of the battery is increased, for example, the lower valve 24a is deformed so as to push the upper valve 24b toward the cap 26 and is ruptured to interrupt the current path between the lower valve 24a and the upper valve 24b. If the internal pressure is further increased, the upper valve 24b is ruptured and allows the gas to be discharged through the opening in the cap 26. If the internal pressure is further raised, the exhaust valve 28 is ruptured to allow the gas to be discharged through the exhaust valve 28. The lower valve 24a may be replaced by a plate-shaped conductive member having a through-hole, or may be omitted by adopting a structure in which the upper valve 24b is welded to the upper side of the bottom plate 23.

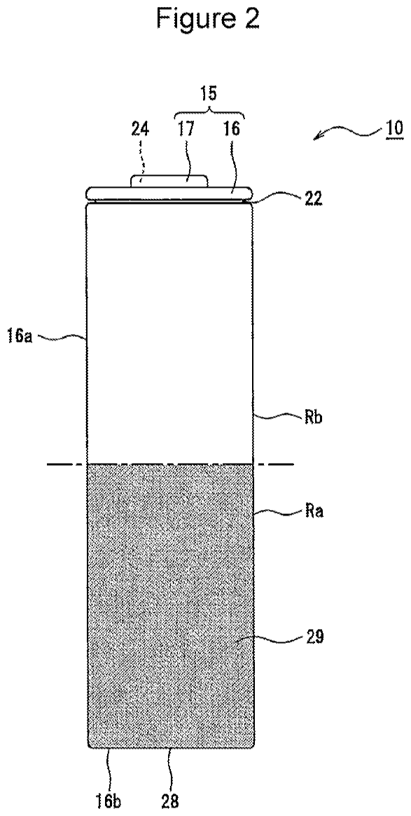

FIG. 2 is a front view of the cylindrical battery 10. The alternate long and short dashed line in FIG. 2 indicates the axial center (the center in the vertical direction) of the battery case 15. In the cylindrical battery 10, the outer peripheral surface of the battery case 15 which corresponds to the outer peripheral surface of the exterior casing 16 (the sidewall portion 16a) is configured so that the emissivity differs between a region Ra (a first region) extending from the axial center of the battery case 15 to the same side as the bottom portion 16b, and a region Rb (a second region) extending from the axial center of the exterior casing 16 to the same side as the sealing unit 17. Here, the emissivity is measured with an infrared radiation thermometer (JIS 1423). The emissivity is an indicator of how easily a material absorbs infrared radiations. A material with higher emissivity absorbs infrared radiations more easily and is more heated by the radiant heat.

When, as described hereinabove, the exhaust valve 28 is provided at the bottom portion 16b of the exterior casing 16 and the exhaust valve 24 is disposed in the sealing unit 17, a large amount of gas can be efficiently discharged through the exhaust valve 28 and the gas discharge route passing the exhaust valve 28 is unlikely to be blocked. Thus, when the cylindrical battery 10 is provided with two exhaust valves 24 and 28, it is preferable that the region Ra of the outer peripheral surface of the battery case 15 that extends from the axial center of the battery case 15 to the same side as the bottom portion 16b have a higher emissivity than the region Rb located on the same side as the sealing unit 17.

At least part of the region Ra is provided with an infrared absorbing layer 29 that is formed of a material having a higher emissivity than the material forming the exterior casing 16. That is, in the present embodiment, the infrared absorbing layer 29 is provided on the region Ra to ensure that the emissivities of the outer peripheral surface of the exterior casing 16 satisfy region Ra>region Rb. Alternatively, an infrared reflective layer that reflects infrared radiations may be provided on at least part of the region Rb to ensure that the emissivities satisfy region Ra>region Rb. In order to increase the difference in emissivity between the region Ra and the region Rb and to enhance the effect of protecting the exterior casing 16 from a lateral burst, it is preferable to provide an infrared absorbing layer 29 on the region Ra. In the present disclosure, the infrared absorbing layer 29 provided on the exterior casing 16 is included as part of the battery case 15.

A preferred example of the infrared absorbing layers 29 is a film containing a filler with a high infrared absorptivity (emissivity). In this case, the infrared absorbing layer 29 is formed by applying a paint containing the filler onto the outer peripheral surface of the exterior casing 16. For example, the infrared absorbing layer 29 may be a black film containing a black pigment or may be a film of a color other than black. The thickness of the infrared absorbing layer 29 is not particularly limited, but is preferably 10 μm to 500 μm.

The infrared absorbing layer 25 may be a thin layer formed by a thin film forming method such as plating, deposition or sputtering. The infrared absorbing layer 25 may be, for example, a chrome plating layer. Further, the infrared absorbing layer 29 may be provided by attaching to the exterior casing 16 an insulating tube that includes a layer containing a filler with a high infrared absorptivity or a layer made of a material with a high infrared absorptivity, or by applying an adhesive tape to the exterior casing 16.

The area of the infrared absorbing layer 29 is preferably 25% to 50% of the total area of the outer peripheral surface of the exterior casing 16. While part, of the infrared absorbing layer 29 may be disposed on the region Rb, it is preferable that more than 50% of the total area of the infrared absorbing layer 29 be found on the region Ra. It is more preferable that most (substantially the whole) or the whole of the infrared absorbing layer 29 be found on the region Ra. In the example illustrated in FIG. 2, the infrared absorbing layer 29 is disposed only on the region Ra. By forming the infrared absorbing layer 29 over an area in the range of 25% to 50% of the total area of the outer peripheral surface of the exterior casing 16, the region Ra of the exterior casing 16 will be selectively heated when a nearby battery generates abnormal heat, and the exterior casing 16 is prevented from a lateral burst more reliably.

In the region Ra of the exterior casing 16, the infrared absorbing layer 29 may be disposed on a portion of the region Ra, for example, in the vicinity of the bottom portion 16b, in the vicinity of the axial center of the exterior casing 16, or in the middle between the bottom portion 16b and the axial center. Alternatively, the infrared absorbing layer 29 may be disposed on most (substantially the whole) or the whole of the region Ra. The area of the infrared absorbing layer 29 is, for example, 50% to 100% of the total area of the region Ra. Regardless of whether the infrared absorbing layer 29 is disposed on part of the region Ra or on the whole of the region Ra, the infrared absorbing layer 29 preferably extends over the entire circumferential length of the region Ra. That is, the infrared absorbing layer 29 is preferably formed as a continuous ring along the circumferential direction of the exterior casing 16.

The exhaust valve 28 is operated more smoothly and the occurrence of a lateral burst in the exterior casing 16 is more unlikely with increasing difference in emissivity between the region Ra and the region Rb of the outer peripheral surface of the exterior casing 16. Specifically, the difference in emissivity between the region Ra and the region Rb is preferably not less than 0.35, more preferably not less than 0.4, and particularly preferably not less than 0.5.

The cylindrical battery 10 is sufficiently prevented from the occurrence of a lateral burst in the exterior casing 16. Thus, the cylindrical batteries 10 are preferably used in a battery module in which the batteries are arranged in such a manner that the outer peripheral surfaces of the battery cases are opposed to one another. An example of the battery modules of the present disclosure is a battery module that includes a plurality of the cylindrical batteries 10 arranged on the same plane while the axial directions of the respective battery cases 15 are parallel to one another.

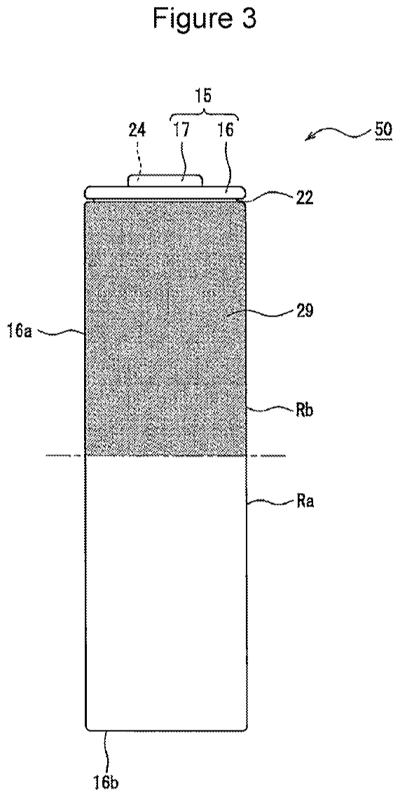

FIG. 3 is a front view of a cylindrical battery 50 according to another exemplary embodiment. The cylindrical battery 50 differs from the cylindrical battery 10 in that the exhaust valve 28 is not disposed on the bottom portion 16b of the exterior casing 16. In the cylindrical battery 50, an infrared absorbing layer 29 is disposed on a region Rb of the outer peripheral surface of the exterior casing 16 that extends from the axial center of the exterior casing 16 to the same side as the sealing unit 17. That is, the outer peripheral surface of the exterior casing 16 is configured so that the region Rb (a first region) extending from the axial center of the exterior casing 16 to the same side as the exhaust valve 24 has a higher emissivity than a region Ra (a second region) located on the side opposite to the exhaust valve 24. In this case, the gas generated inside the battery can be smoothly discharged through the exhaust valve 24, and the exterior casing 16 can be sufficiently prevented from a lateral burst.

The area of the infrared absorbing layer 29 is preferably 25% to 50% of the total area of the outer peripheral surface of the battery case 15, and more than 50% of the total area of the infrared absorbing layer 29 is found on the region Rb. In the example illustrated in FIG. 3, the infrared absorbing layer 29 is disposed only on the region Rb. Farther, the infrared absorbing layer 29 is disposed on the region Rb from immediately below the grooved portion 22 to the axial center of the exterior casing 16. The structure of the cylindrical battery may be such that the sealing unit has no exhaust valves and only the bottom portion of the exterior casing has an exhaust valve. In this case, it is preferable that the emissivity of the region located on the bottom portion side of the exterior casing be higher than the emissivity of the region located on the sealing unit side, similarly to the example illustrated in FIG. 2.

### Examples

Hereinbelow, the present disclosure will be further described based on EXAMPLE. However, it should be construed that the scope of the present disclosure is not limited to such EXAMPLE.

### Comparative Example

[Fabrication of Positive Electrode]

Lithium metal composite oxide represented by LiNi_{0.88}Co_{0.09}Al_{0.03}O₂ was used as a positive electrode active material. The positive electrode active material, carbon black and PVdF were mixed together in a mass ratio of 100:1.0:0.9, and an appropriate amount of N-methyl-2-pyrrolidone was added. Thereafter, the mixture was kneaded to give a positive electrode mixture slurry. The positive electrode mixture slurry was applied to both sides of a positive electrode current collector made of a 15 μm thick aluminum foil. The wet films were dried, and the coatings were rolled using a roller. Thereafter, the long sheet composed of the current collector and the mixture layers on both sides was cut into a predetermined electrode size. Thus, a positive electrode having a thickness of 0.15 mm, a width of 63 mm and a length of 360 mm was fabricated. A positive electrode lead made of aluminum was attached to an exposed portion of the current collector of the positive electrode.

### [Fabrication of Negative Electrode]

A negative electrode active material was prepared by mixing graphite with a Si-containing compound in a mass ratio of 94:6. The Si-containing compound was carbon-coated particles composed of a matrix of lithium silicate Li₂Si₂O₅ and dispersed phases of silicon particles. The negative electrode active material, CMC and a SBR dispersion were mixed together in a solid mass ratio of 100:1.0:1.0, and an appropriate amount of water was added. Thereafter, the mixture was kneaded to give a negative electrode mixture slurry. The negative electrode mixture slurry was applied to both sides of a negative electrode current collector made of an 8 μm thick copper foil. The wet films were dried, and the coatings were rolled using a roller. Thereafter, the long sheet composed of the current collector and the mixture layers on both sides was cut into a predetermined electrode size. Thus, a negative electrode having a thickness of 0.15 mm, a width of 66 mm and a length of S60 mm was fabricated. A negative electrode lead having a nickel/copper/nickel stack structure was attached to an exposed portion of the current collector of the negative electrode.

### [Fabrication of Electrode Assembly]

The positive electrode and the negative electrode were wound together via a polyethylene separator to form a cylindrical wound electrode assembly.

[Preparation of nonaqueous electrolyte]

Vinylene carbonate was dissolved with a concentration of 4 mass % into a mixed solvent containing ethylene carbonate, fluoroethylene carbonate and dimethyl carbonate in a volume ratio of 1:1:3. Thereafter, LiPF₆ was dissolved therein with a concentration of 1.5 mol/L. A nonaqueous electrolyte was thus prepared.

### [Fabrication of Battery]

Insulating plates were arranged above and below the electrode assembly. The negative electrode lead was welded to the inner side of a bottom portion of an exterior casing, and the positive electrode lead was welded to a bottom plate of a sealing unit. The electrode assembly and the insulating plates were then inserted into the exterior casing. The sealing unit was provided with an exhaust valve that was designed to open when the pressure inside the battery case exceeded a predetermined threshold. The exterior casing was a bottomed cylindrical container that was made of a metal principally including iron, and the emissivity of the outer peripheral surface thereof was 0.25. No exhaust valves were provided at the bottom portion of the exterior casing. To ensure that the advantageous effects of the present invention would be markedly obtained in a heating test described later, the exterior casing used herein had a thinner sidewall than usual. The electrolytic solution was poured into the exterior casing accommodating the electrode assembly, and thereafter the open end portion of the exterior casing was crimped to fix the sealing unit via a gasket. Thus, a nonaqueous electrolyte secondary battery with a cylindrical battery case was fabricated. The outer diameter of the battery was 21 mm. The height of the battery was 70 mm. The design capacity of the battery was 4700 mAh.

### Example

A nonaqueous electrolyte secondary battery was fabricated in the same manner as in COMPARATIVE EXAMPLE, except that a black film as an infrared absorbing layer was formed on the outer peripheral surface of the exterior casing. The black film was formed by spraying a black paint to the outer peripheral surface of the exterior casing so as to coat substantially the whole of a region extending from the axial center of the exterior casing to the same side as the sealing unit. The emissivity of the region coated with the black film was 0.6. The emissivity changed at the axial center of the exterior casing, and was 0.6 in the region on the same side as the exhaust valve (the sealing unit) and was 0.25 in the region on the side opposite to the exhaust valve, the difference being 0.35.

### [Heating Test (Evaluation of Lateral Burst of Exterior Casing)]

The batteries of COMPARATIVE EXAMPLE and EXAMPLE were evaluated by the following procedures. The test was conducted on five batteries of COMPARATIVE EXAMPLE and five batteries of EXAMPLE. The evaluation results (the numbers of laterally burst exterior casings) are described in Table 1.

(1) The battery was fully charged by CC-CV charging.
(2) The fully charged battery was placed in a heating furnace at 300° C. and was heated by radiant heat to forcibly induce thermal runaway.
(3) After the thermal runaway of the battery, the battery was taken out from the heating furnace and was inspected for the presence or absence of a lateral burst in the exterior casing.

TABLE 1

| | COMPARATIVE | |
|---|---|---|
| | EXAMPLE | EXAMPLE |
| Black film | Absent | Present |
| Incidence of lateral burst | 4/5 | 0/5 |
| in exterior casing | | |

As described in Table 1, the heating test of the COMPARATIVE EXAMPLE batteries having no black films resulted in the occurrence of a lateral burst in four of the five exterior casings, while the EXAMPLE batteries which had a black film did not suffer any lateral bursts in the exterior casings. In the EXAMPLE batteries, it is probable that the black film absorbed the radiant heat, and consequently the portion of the exterior casing on the exhaust valve side was preferentially heated to allow the gas to be smoothly discharged through the exhaust valve, thereby protecting the exterior casing from a lateral burst. The batteries of EXAMPLE can constitute a battery module that attains enhanced module safety by virtue of the reduced occurrence of thermal propagation between the batteries stemming from a lateral burst in the exterior casing.

### REFERENCE SIGNS LIST

10, 50 CYLINDRICAL BATTERIES, 11 POSITIVE ELECTRODE, 12 NEGATIVE ELECTRODE, 13 SEPARATOR, 14 ELECTRODE ASSEMBLY, 15 BATTERY CASE, 16 EXTERIOR CASING, 16a SIDEWALL PORTION, 16b BOTTOM PORTION, 17 SEALING UNIT, 18, 19 INSULATING PLATES, 20 POSITIVE ELECTRODE LEAD, 21 NEGATIVE ELECTRODE LEAD, 22 GROOVED PORTION, 23 BOTTOM PLATE, 23a THROUGH-HOLE, 24, 28 EXHAUST VALVES, 24a LOWER VALVE, 24b UPPER VALVE, 25 INSULATING MEMBER, 26 CAP, 27 GASKET, 28a GROOVE, 29 INFRARED ABSORBING LAYER

1. A cylindrical battery comprising a cylindrical battery case comprising a bottomed cylindrical exterior casing and a sealing unit fitted to close an opening of the exterior casing, wherein
a bottom portion of the exterior casing, or the sealing unit is provided with an exhaust valve, and
an outer peripheral surface of the battery case has a higher emissivity in a first region extending from an axial center of the battery case to the same side as die exhaust valve than in a second region located on a side opposite to the exhaust valve.

2. A cylindrical battery comprising a cylindrical battery case comprising a bottomed cylindrical exterior casing and a sealing unit fitted to close an opening of the exterior casing, wherein
a bottom portion of the exterior casing, and the sealing unit are each provided with an exhaust valve, and
an outer peripheral surface of the battery case has a higher emissivity in a first region extending from an axial center of the battery case to the same side as the bottom portion than in a second region located on the same side as the sealing unit.

3. The cylindrical battery according to claim 1, wherein the difference in emissivity between the first region and the second region is not less than 0.35.

4. The cylindrical battery according to claim 1, wherein at least part of the first region is provided with an infrared absorbing layer formed of a material having a higher emissivity than a material forming the exterior casing.

5. The cylindrical battery according to claim 4, wherein the area of the infrared absorbing layer is 25% to 50% of the total area of the outer peripheral surface.

6. A battery module comprising a plurality of the cylindrical batteries described in claim 1, wherein
the cylindrical batteries are arranged on the same plane while axial directions of the respective battery cases are parallel to one another.

7. The cylindrical battery according to claim 2, wherein the difference in emissivity between the first region and the second region is not less than 0.35.

8. The cylindrical battery according to claim 2, wherein at least part of the first region is provided with an infrared absorbing layer formed of a material having a higher emissivity than a material forming the exterior casing.

9. The cylindrical battery according to claim 8, wherein the area of the infrared absorbing layer is 25% to 50% of the total area of the outer peripheral surface.

10. A battery module comprising a plurality of the cylindrical batteries described in claim 2, wherein
the cylindrical batteries are arranged on the same plane while axial directions of the respective battery cases are parallel to one another.
